(19) United States
(12) Patent Application Publication
(10) Pub. No.: US 2015/0254578 A1
(43) Pub. Date: Sep. 10, 2015

(54) CLOUD SERVER FOR PROVIDING BUSINESS CARD PAGE AND METHOD FOR PROVIDING BUSINESS CARD PAGE ON THE CLOUD SERVER

(71) Applicant: Ikjoo CHI, Seoul (KR)

(72) Inventor: Ikjoo CHI, Seoul (KR)

(21) Appl. No.: 14/638,233

(22) Filed: Mar. 4, 2015

(30) Foreign Application Priority Data
Mar. 5, 2014 (KR) 10-2014-0026232

(51) Int. Cl. G06Q 10/00; H04L 29/08; H04L 29/06; G06Q 10/10

(52) U.S. Cl. CPC G06Q 10/00; G06Q 10/107; H04L 67/12; H04L 63/083

(57) ABSTRACT

Disclosed are a cloud server for providing a business card page and a method for providing a business card page on the cloud server. The cloud server includes: a business card page storing module storing a business card page of a user corresponding to an ID/email address registered during an initial member joining procedure; an ID/email address searching module receiving at least one of the ID/email address of the user from a predetermined counterpart terminal and when the received ID/email address is compared with the ID/email address which is advancingly registered and both IDs/email addresses coincide with each other, searching the ID/email address so as to inquire the corresponding business card page; and a business card page transmitting module transmitting the business card page stored in the business card page storing module to the counterpart terminal connected through a control module; the control module controlling the business card page storing module to search the business card page corresponding to at least one of the IDs/email addresses searched by the ID/email address searching module and the searched business card page to be viewed to the counterpart terminal through the business card page transmitting module; and a counterpart editing/storing module allowing the counterpart terminal to additionally prepare a counterpart's unique memo on a user business card page.

### CROSS-REFERENCE TO RELATED APPLICATIONS

This application claims priority to and the benefit of Korean Patent Application No. 10-2014-0026232 filed in the Korean Intellectual Property Office on Mar. 5, 2014, the entire contents of which are incorporated herein by reference.

### TECHNICAL FIELD

The present invention relates to providing and managing a business card, and particularly, to providing and managing a webpage type business card based on a cloud and further, to a cloud server for providing a business card page and a method for providing the business card page.

### BACKGROUND ART

In the related art, business cards are exchanged with each other by a business purpose or various other purposes. In the case of the existing business card, various pieces of information is written in paper, such as a name, a duty, a cell phone number, an email address, an office phone number, an office address, a fax number, and the like.

When numerous paper business cards are received from multiple clients, since numerous paper business cards should be individually written in own cell phones or computers, it is difficult to manage contact numbers of the clients or acquaintances.

In order to solve the problem, an application or a device that scans and automatically inputs the paper business card is used, but the number of scan errors is not small and the scan errors should be individually modified, and input and stored again, it is inconvenient similarly.

Meanwhile, the business card in the related art just has 4 cm wide×6 cm long and is disadvantageous in that the business card is inadequate in containing matters to express and advertise the person concerned in the small business card. That is, the business card in the related art is also disadvantageous that the business card cannot contain separate information in addition to a simple contact number. Since one business card is just one of numerous business cards in terms of a person who receives the business card, there is a problem that it is not easy to distinguish who is who.

Further, since the business card needs to be newly printed again when the cell phone number, the office number, the office address, and the like are changed, the existing business card becomes frequently useless and the resulting waste cannot but be too much.

There is a problem that the business card needs to be newly and printed even though only one of the multiple pieces of information is changed.

Meanwhile, in recent years, as the spread of smart phones has been generalized, contact number information equivalent to the information written in the paper business card could have all been contained and stored in an address directory of the smart phone. However, since the paper business card needs to be scanned or the information of the paper business card needs to be individually input even in the smart phone, it is not significantly enhanced in terms of managing the business card.

Of course, it is advantageous that the changed information can be easily managed by updating the address directory of the smart phone, but when the smart phone is lost, there is a high risk that the information will be lost/deleted as long as the information is not backed up in a separate back-up server.

Further, in that information included in the smart phone address directory or a business card management application is just the information written in the existing paper business card and more information is not included, a case cannot but occur, in which the information cannot be still distinguished after time elapses.

### SUMMARY OF THE INVENTION

The present invention has been made in an effort to provide a cloud server for providing a business card page.

Further, the present invention has been made in an effort to provide a method for providing a business card page of a cloud server.

An exemplary embodiment of the present invention provides a cloud server for providing a business card page, including: a business card page storing module storing a business card page of a user corresponding to an ID/email address advancingly registered; an ID/email address searching module receiving at least one of the ID/email address of the user from a predetermined counterpart terminal and when the received ID/email address is compared with the ID/email address which is advancingly registered and both IDs/email addresses coincide with each other, searching the ID/email address so as to inquire the corresponding business card page; and a business card page transmitting module transmitting the business card page stored in the business card page storing module to the counterpart terminal connected through a control module; and the control module controls the business card page storing module to search the business card page corresponding to at least one of the IDs/email addresses searched by the ID/email address searching module and the business card page transmitting module to transmit the searched business card page to the counterpart terminal.

In this case, the cloud server may be configured to further include an ID/email address providing module providing a business card page list in which the ID/email address, a name of the user, an image, or a region is written so as for the counterpart terminal to search the business card page.

The control module may be configured to control the ID/email address searching module to transmit an authentication request to the user terminal according to an advance set-up of the user when receiving an ID and an email address from the counterpart terminal and the business card page transmitting module to transmit a business card page corresponding to the ID and the email address to the counterpart terminal when the user decides the authentication.

The ID/email address searching module may be configured to receive QR code data from the counterpart terminal, and compare the received QR code data and the QR code data of the user, which is advancingly registered in the business card page storing module to verify whether both QR code data match each other.

The cloud server may be configured to further include a business card page generating/updating module configured to receive the business card information from the user terminal, generate the business card page by using the business card information received from the user terminal and store the generated business card page in the business card page storing module or update and store the prestored business card page in the business card page storing module, and allow the counterpart terminal who accesses the corresponding user business card page storing module once or more to separately store a counterpart's unique memo content in the user business card page storing module or update and separately store the counterpart's unique memo content prestored in the business card page storing module.

The control module may be configured to control the business card page generating/updating module to generate one business card page among an office related business card page, a personal introduction business card page, a club/organization related business card page, and an enterprise business card page to correspond to the ID of the user, the email address of the user, a combination of the ID and the email address.

Meanwhile, the control module may be configured to arrange and provide a latest list item sequence and the name of the user, a region, a classification, a preference emoticon, and the like for each sequence when the counterpart terminal logs in with respect to the user business card page list which the counterpart terminal has accessed through a first security access verification procedure on the Web so as to continuously inquire the user business card page list without an additional reverification procedure and control the business card page transmitting module to provide a specific business card page in the user list to the counterpart terminal according to a request by the counterpart terminal.

On the other hand, the business card page storing module may store the business card page for each language.

Another exemplary embodiment of the present invention provides a method for providing a business card page on a cloud server, including: receiving, by an ID/email address searching module, at least one of ID/email addresses of predetermined users from predetermined counterpart terminals; comparing, by the ID/email address searching module, at least one of the received IDs/email addresses and an advancingly registered ID/email address corresponding thereto to verify whether both IDs/email addresses match each other; allowing, by the control module, the business card page storing module to search the business card page corresponding to at least one of the IDs/email addresses searched by the ID/email address searching module; and controlling, by the control module, a business page transmitting module to view the searched business card page or the user business card page list that has been accessed to the counterpart terminal.

Herein, the method may further include before the receiving, by an ID/email address searching module, at least one of an ID/email address of a predetermined user from a predetermined counterpart terminal, receiving, by a business card page generating/updating module, business card information from a user terminal; and generating, by the business card page generating/updating module, the business card page by using the received business card information and storing the generated business card page in the business card page storing module or update and store the prestored business card page in the business card page storing module.

In the comparing, by the ID/email address searching module, at least one of the received IDs/email addresses and an advancingly registered ID/email address corresponding thereto to verify whether both IDs/email addresses match each other, when the ID/email address searching module receives that both IDs and email addresses match each other from the counterpart terminal, the control module may be configured to additionally transmit an authentication request to the user terminal and as a result, permit access of the corresponding counterpart terminal to the corresponding business page storing module only when receiving the authentication information from the user terminal, and in the controlling, by the control module, a business page transmitting module to view the searched business card page to the counterpart terminal, when the counterpart terminal is authenticated by the control module, the business card page transmitting module may be configured to view a business card page corresponding to the ID and the email address to the counterpart terminal.

In the receiving, by an ID/email address searching module, at least one of an ID/email address of a predetermined user from a predetermined counterpart terminal, the ID/email address searching module may be configured to substitutively receive QR code data from the counter part terminal, in the comparing, by the ID/email address searching module, at least one of the received IDs/email addresses and an ID/email address corresponding thereto to verify whether both IDs/email addresses match each other, when the QR code data is received from the counterpart terminal, the received QR code data and the QR code data prestored in the business card page storing module may be configured to be compared with each other to search whether both QR code data match each other, and in the allowing, by the control module, the business card page storing module to search the business card page corresponding to at least one of the IDs/email addresses searched by the ID/email address searching module, the business card page advancingly stored in the business card page storing module to correspond to the searched QR code data may be configured to be searched.

In the generating, by the business card page generating/updating module, the business card page by using the received business card information and storing the generated business card page in the business card page storing module or update and store the prestored business card page in the business card page storing module, the business card page may be configured to be generated or updated by accessing the business card page with the email address and a unique password.

In the generating, by the business card page generating/updating module, the business card page by using the received business card information and storing the generated business card page in the business card page storing module or update and store the prestored business card page in the business card page storing module, the user may be configured to generate one business card page among an office-associated business card page, a personal introduction business card page, a club/organization-associated business card page, and a personal enterprise business card page according to user selection during a subscription procedure.

The method may be configured to further include arranging and providing, by the control module, a item list constituted by combinations of an image, a name, a region, a classification, a preference emoticon, a phone number/email address, and the like of the user on the Web according to a name sequence, a region sequence, a classification sequence, a preference emoticon sequence, and the like in addition to a latest access sequence so as for the counterpart terminal to inquire the user on the Web according to a specific sequence; and providing, by the business card page transmitting module to the business card page of the user to the counterpart terminal according to a request by the counterpart terminal.

### Effects of the Invention

According to the cloud server for providing the business card page and the providing method thereof, as a method in which a user prepares a business card page containing his/her own image and even his/her introduction or promotion contents such as a resume as well as his/her own name, phone number, and address and thereafter, can inquire the business card page, an ID, an email address, or a combination thereof is provided to a counterpart and the counterpart inputs the ID, the email, or the combination thereof on an application or the Web and when the input ID, email, or combination thereof matches a predetermined ID, email, or combination thereof through an access verification procedure, the user is configured to access the business card page to prevent management inconvenience of management of the existing paper business card and more conveniently inquire information on the counterpart. Information of the business card need not individually be input in a server on the Web or a cellular phone and when the ID of the user, the email of the user, or the combination thereof is verified only first once, the business card page of the user can be inquired through the cloud server anytime in the terminal such as the cellular phone as if the information of the business card is individually input, and as a result, separate business card management is not required.

Further, although vast quantity of business card page list are possessed, a list item to be found can be easily searched through a search or a latest sequence, a name sequence, a region, a classification such as a friend/business/family/others, and the like, a classification depending on a preference emoticon, and the like, and a keyword search.

In addition, since the user who generates the business card modifies a contact number or an address to update the contact number or address on the cloud server even though the contact number or address is changed, the business card need not individually reprinted or prepared differently depending on a purpose.

Moreover, the business card page can be provided while security is further strengthened through a QR code or authentication, and as a result, the user may expose his/her own business card page to a desired counterpart.

Further, information which the user likes to introduce himself/herself such as a photo, a resume, promotion contents or an introduction letter is configured in the business card page in addition to the existing name, contact number, address, duty, and the like to break from conformality of the existing business card or address directory and promote/advertise the user or user's enterprise through a promotion/advertisement webpage.

Meanwhile, contrary to the QR code or authentication method, when the user selects a method that does not use the ID or email address thereof as a verification procedure tool in terms of the security, while a business card page control module is set in an open mode, as if the counterpart finds a specific business at the existing yellow page only through searching the name of the user, the region, or words on the business card page, that is, a related keyword, all business card page list corresponding thereto can be searched and the corresponding business card page can be inquired on the Web.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a block diagram of a cloud server for providing a business card page according to an exemplary embodiment of the present invention.

FIGS. 2 to 6 are exemplary diagrams of a user interface screen according to the exemplary embodiment of the present invention.

FIG. 7 is a flowchart of a method for providing a business card page of a cloud server according to another exemplary embodiment of the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

The present invention may have various modifications and various embodiments and specific exemplary embodiments will be illustrated in the drawings and described in detail in the detailed contents for carrying out the invention. However, this is not intended to limit the present invention to the specific exemplary embodiments, and it should be understood that the present invention covers all the modifications, equivalents and replacements included in the spirit and technical scope of the present invention. Like reference numerals refer to like elements while describing each drawing.

Terms such as first, second, A, B, and the like may be used to describe various components but the components are not limited by the above terminologies. The above terms are used only to discriminate one component from another component. For example, without departing from the scope of the present invention, a first component may be referred to as a second component, and similarly, the second component may also be referred to as the first component. A term “and/or” includes a combination of a plurality of associated disclosed items or any item of the plurality of associated disclosed items.

It should be understood that, when it is described that an element is “coupled” or “connected” to another element, the element may be “directly coupled” or “directly connected” to the other element or “coupled” or “connected” to the other element through a third element. In contrast, it should be understood that, when it is described that an element is “directly coupled” or “directly connected” to another element, it is understood that there are no intervening elements.

Terms used in the present application are used only to describe specific exemplary embodiments, and are not intended to limit the present invention. Singular expressions used herein include plurals expressions unless they have definitely opposite meanings in the context. In the present application, it should be understood that term “include” or “have” indicates that a feature, a number, a step, an operation, a component, a part or the combination thereof described in the specification is present, but does not exclude a possibility of presence or addition of one or more other features, numbers, steps, operations, components, parts or combinations, in advance.

If it is not contrarily defined, all terms used herein including technological or scientific terms have the same meanings as those generally understood by a person with ordinary skill in the art. It should be understood that terms defined in a generally used dictionary have meanings which are the same as contextual meanings of associated techniques and if not apparently defined in this application, the terms should not be interpreted as ideological or excessively formal meaning.

Hereinafter, exemplary embodiments of the present invention will be described in detail with reference to the accompanying drawings.

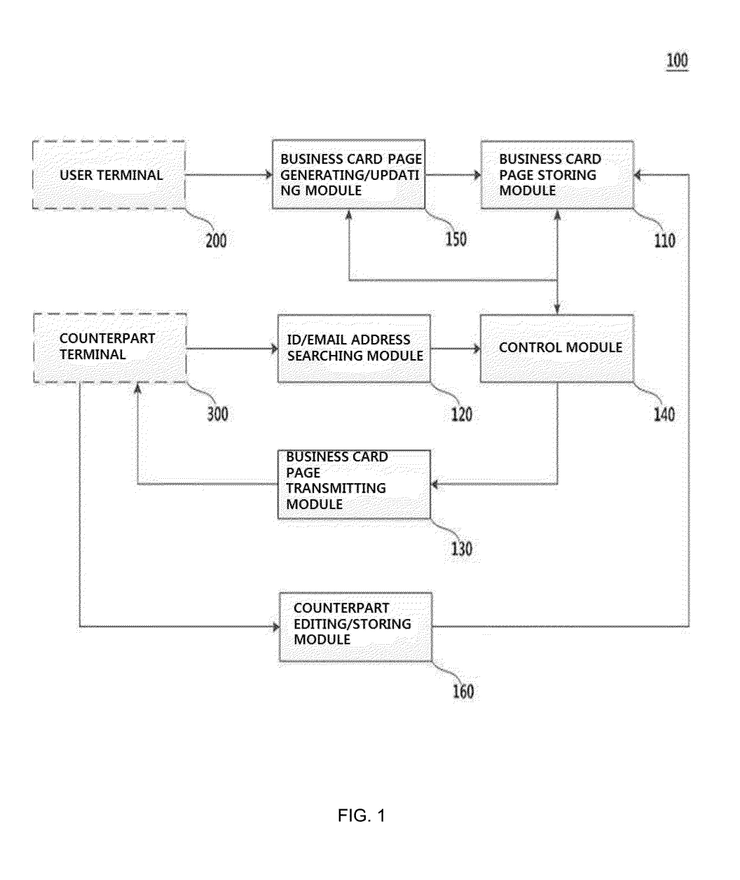

FIG. 1 is a block diagram of a cloud server for providing a business card page according to an exemplary embodiment of the present invention.

In the present invention, a ‘user’ is called a person who provides his/her own ID or email address or a combination thereof and a related QR code in order to permit external access to his/own business card as a means for preparing and managing his/her own personal information and furthermore, and introducing himself/herself in a business card page which becomes a principal agent of the present invention. The user corresponds to a provider who serves to actually give the business card page.

In the present invention, a ‘counterpart’ is called a person who searches and inquires the business card page of the user which becomes the main agent of the present invention from the user. Therefore, the counterpart corresponds to a receiver that receives the corresponding business card page from the user.

In the present invention, by considering a configuration environment of the business card page, a business card page having a property of a personal page primarily containing personal information, a business card page having a property to primarily contain business information like a business directory, and a page having a property of a group like a club are referred to as a white page, a yellow page, and a green page, respectively.

Referring to FIG. 1, the cloud server (hereinafter, referred to as ‘cloud server’) 100 for providing the business card page according to the exemplary embodiment of the present invention may be configured to include a business card page storing module 110, an ID/email address searching module 120, a business card page transmitting module 130, a control module 140, a business card page generating/updating module 150, and a counterpart editing/storing module 160.

The cloud server 100 is configured to overcome problems of the existing paper business card, an address directory of a smart phone, or a business card management application and more efficiently and safely (achieve management of the business card and configured to discard conformality of information written in the business card, and generate and distribute business card pages of various purposes according to a purpose desired by the user.

The business card page is not directly stored or managed in a cellular phone or a PC, but the business card page is configured to be stored in the cloud server 100 and updated according to a request by a user terminal 200 and a counterpart terminal 300 is configured to inquire a list of the business card pages or a specific business card page immediately anytime in the state where the counterpart terminal logs in after a security procedure is verified by using the ID of the user, the email address of the user, or a combination thereof.

The counterpart terminal 300 may access the cloud server 100 through a dedicated application or a webpage and a list of users who access the cloud server 100 through a minimum of one security procedure in the meantime is configured to be arranged on an initial screen of the counterpart terminal 300 who logs in for each latest sequence, name sequence, classification, and the like for each sequence. When a specific name, classification, or keyword is searched on the list, only a list corresponding thereto may be limited and reinquired from the cloud server 100 and fields such as the latest sequence, the name, the classification, and the like may also be rearranged according to a desired priority and when a specific item is selected among them, the corresponding business card page is configured to be received.

In a cloud scheme having the function, a terminal which may access the Internet may safely inquire business card information possessed by the counterpart himself/herself, which is stored in the cloud server 100 regardless of place or time. Further, the business card information need not be individually written or modified on the smart phone and since new information is consistently updated by the user terminal 200, it is advantageous to maintain latest information.

Further, since one business card page exists to correspond to a unique email address or a unique ID, if the user has a plurality of email addresses, business card pages having different properties may be additionally provided in the application by using an email address which has not yet been used. That is, a desired favorite business card page is selected and generated among business card pages having different properties such as a personal introduction purpose, an advertisement purpose of a personal enterprise, an office associated introduction purpose, a club purpose, and the like to selectively provide an appropriate business card page depending on the counterpart.

In addition, one business card page is provided to correspond to the unique email address/ID and the same user may have multiple email addresses/IDs and it is a principle that the email address and the ID may not exist to overlap. That is, when it is assumed that there is a user who uses an email of patent@uddress.com and ‘iky’ as the ID, the ID, ‘iky’ may not be used even though a different email is used and the email address of patent@uddress.com may not also be used even though a different ID is used.

However, since any same user may have two or more email addresses/IDs, users having an email address/ID, trademark@gmail.com/kwon and an email address/ID, design@yahoo.com/chi, and the like may exist and different pieces of information may be set in the business card pages corresponding to the email addresses/IDs of the users. For example, the business card page (hereinafter, referred to as A page) corresponding to patent@uddress.com/iky is a page provided to a person having lowest intimacy, the business card page (hereinafter, referred to as C page) corresponding to trademark@gmail.com/kwon is a page provided to a person having highest intimacy, such as a family or a lover, and the business card page (hereinafter, referred to as B page) corresponding to design@yahoo.com/chi may be a page provided to a person having medium intimacy.

In this case, in the case where the counterpart finds only the email address and in the case where the counterpart finds only the ID, and in the case where the counterpart finds both the email address and the ID, accessible business card pages may vary with respect to the respective cases. That is, when the user finds both the email address and the ID, the accessible page is decided as the C page, when the user finds only the email address, the accessible page is decided as the A page, and when the user finds only the ID, the accessible page is decided as the B page, and thereafter, both trademark@gmail.com and kwon, only patent@uddress.com, and only chi are notified to decide a substantial exposure degree of the business card information, according to a degree of the intimacy.

As a result, the users provide different email addresses/IDs according to intimacy with the counterpart and a type of a relation to differentiate user information provided to the counterpart.

Of course, there may be a method in which all user information is input in one email address/ID and an information exposure permission level in one page of the corresponding business card page vary according to an authentication or an authentication level.

That is, an ID or email address which is accessible to the business card page for advertising the personal enterprise may be transferred to a client of the personal enterprise and the ID or email address which is accessible to the business card page for personal introduction may be transferred to an acquaintance having a private relation.

Meanwhile, the user is configured to permit accessing the corresponding business card page only when the counterpart know all of the combinations of the ID and the email address with respect to information which the user intends to expose only significantly personal intimacies or the corresponding counterpart terminal 300 to access the corresponding business card page only through the authentication by the user terminal 200 to maintain the security for each business card page.

Besides, the cloud server 100 may be configured to post on the Web the list of the business card pages which may be opened to everyone without the ID or email address. In this case, the corresponding business card page may substitute for a function of the white page or the yellow page.

Hereinafter, a detailed configuration will be described.

The business card page storing module 110 is configured to store a business card page of a user corresponding to an ID/email address advancingly registered.

The ID/email address searching module 120 is configured to receive at least one of the ID and the email address of the user from a predetermined counterpart terminal 300. That is, the ID/email address searching module 120 is configured to receive any one of the ID, the email address, and a combination of the ID and the email address.

The ID/email address searching module 120 is configured to access the corresponding business card page when at least one of the received IDs/email addresses is compared with the ID/email address which is advancingly registered in the business card page storing module 110 and both IDs/email addresses coincide with each other as a verification procedure required for the counterpart to access the business card page of the user. When the security access verification procedure for the counterpart terminal is performed once as described above, the business card page of the corresponding user or the business card page list item is automatically inquired without an additional verification procedure in the state where the terminal of the corresponding counterpart logs in.

Accordingly, the counterpart terminal 300 may not receive the corresponding business card page until the ID, the email address, or the combination thereof coincides with the ID/email address which is advancingly registered in the business card page storing module 110 at least once.

The business card page transmitting module 130 is configured to transmit the business card page stored in the business card page storing module 110 to the counterpart terminal 300. Herein, the business card page advancingly corresponding to the searched ID, email address, or combination thereof is transmitted. Herein, the ‘transmission’ includes even a role or a function to transmit the corresponding business card page or the corresponding business card page list by selectively opening the business card page storing module previously cut off from the external access so that the counterpart terminal is permitted to access the user business card page, that is, the counterpart terminal views the business card page or the business card page list searched through a first security access verification process as well as actual transmission is performed.

The control module 140 is configured to allow the business card page storing module 110 to search the business card page corresponding to at least one of the IDs/email addresses searched by the ID/email address searching module 120.

The control module 140 controls the business card page transmitting module 130 to transmit the advancingly searched business card page to the counterpart terminal 300.

Meanwhile, the control module 140 may be configured to additionally request authentication to the user terminal 200 and thereafter, allow the resulting corresponding user terminal to perform the authentication or not as well as the ID/email address searching module 120 receives the ID and the email address, that is, the combination of the ID and the email address from the counterpart terminal 300.

In this case, when the control module 140 receives the authentication from the user terminal 200, the business card page transmitting module 130 may be configured to control the business card page transmitting module 130 to transmit the business card page corresponding to the ID and the email address to the counterpart terminal 300.

Herein, the control module 140 may be configured to allow the user to identify the counterpart and therefore, decide the authentication or not by providing information to identify the counterpart, such as a phone number or a name of the counterpart terminal 300 to the user terminal 200.

Meanwhile, the ID or the email address and the combination of the ID and the email address, and QR code data, in itself, generated in the business card page application may be used as a means accessible to the business card page in addition to the means such as the combination and the authentication number. Instead of mutually transferring the ID/email address verbally or transferring the ID/email address printed on paper, a QR code printed on paper may be transferred or a QR code stored in the user terminal 200 may be transferred so that the counterpart terminal 300 immediately recognizes the QR code. The QR code is high in accuracy of transmission as compared with the case of transferring the ID/email address verbally and is generated irrespective of the existing ID/email address, and as a result, it is advantageous that an exposure amount of the ID/email address to an unspecific person may be significantly reduced. In this case, when the business card page is accessed by using the QR code, the corresponding QR code may be configured by a method in which the QR code is generated of itself in a system to be granted irrespective of the existing ID/email combination to decide whether to access the corresponding business card page.

Of course, the QR code is modulated to be generated based on the ID/email address so as to significantly reduce the exposure amount of the ID/email address to the unspecific person. When the business card page is accessed by using the general email address/ID, the email address or ID of the user is exposed to a detailed address of the accessed business card page, while when the business card page is accessed by using the QR code, the email address or ID of the user is not exposed, but the email address or ID is configured to be preferably encrypted or substituted with meaningless codes to be displayed. The reason is that it is preferable that when the business card page is accessed by the QR code, the email address of the user is not exposed.

Therefore, the ID/email address searching module 120 may be configured to receive the QR code data from the counterpart terminal 300 instead of the combination of the ID and the email address, and perform a process of verifying whether the counter terminal 300 is a counterpart that may provide the user's own business card page by comparing the QR code data of the user, which is advancingly stored in the business card page storing module 110 with the received QR code data. In addition, the control module 140 may control business card page information of the matched QR code data to be searched and provided to the counterpart terminal 300.

On the other hand, when the user uniquely uses only the email address as the security access verification procedure in the counterpart terminal 300, the counterpart terminal 300 may be configured to automatically upload the email address of the user who sends and receives the email by using the email application to the list of the business card applications. Therefore, the counterpart terminal 300 may be configured to access the business card page of the person who sends and receives the email anytime.

The business card page generating/updating module 150 may be configured to receive the business card information from the user terminal 200.

The business card page generating/updating module 150 may be configured to generate the business card page by using the business card information received from the user terminal 200 and store the generated business card page in the business card page storing module 110 and configured to update and store the prestored business card page in the business card page storing module 110. When some information is changed, the user changes the information, or the user adds the information, the information may be updated to new information anytime.

Meanwhile, the counterpart terminal 300 may be configured for the counterpart to input and inquire the information by itself in additional to unilateral personal information provided by the user through the counterpart editing/storing module 160 so as to prepare a unique memo of the counterpart on the user business card page.

On another hand, the counterpart may be configured to permit everyone to access the corresponding business card page in spite of not securing the ID and the email address serving as keys which permit accessing the user business card page and the business card page may be accessed when a use right is forgiven as a security means that allows the user to access the ID and the email address of the user to the own business card page. In particular, when the user intends to use the business card page as a means for promotion of a user's own enterprise or widely introducing himself/herself by containing a user's own resume, the business card page may be a big help. That is, when the business card page intends to be used as the white page or the yellow page which has a strong property of an opening function, the use right of the ID or the email address as the tool of the security access verification procedure is forgiven, and as a result, everyone may easily access the business card page through a keyword search. In this case, information contents included in the business card page are opened so as for everyone to inquire the information contents through a search function.

That is, when the business card page information of the user is advancingly set in an open mode, the user terminal 300 may access the corresponding business card page through only the search without the security procedure.

In this case, when an inquiry of the business card page for a specific list item in a list by a search result is requested, the control module 140 may be configured to control the corresponding business card page transmitting module 130 to provide an opened-state user business page to the counterpart terminal 300 according to a request by the counterpart terminal 300.

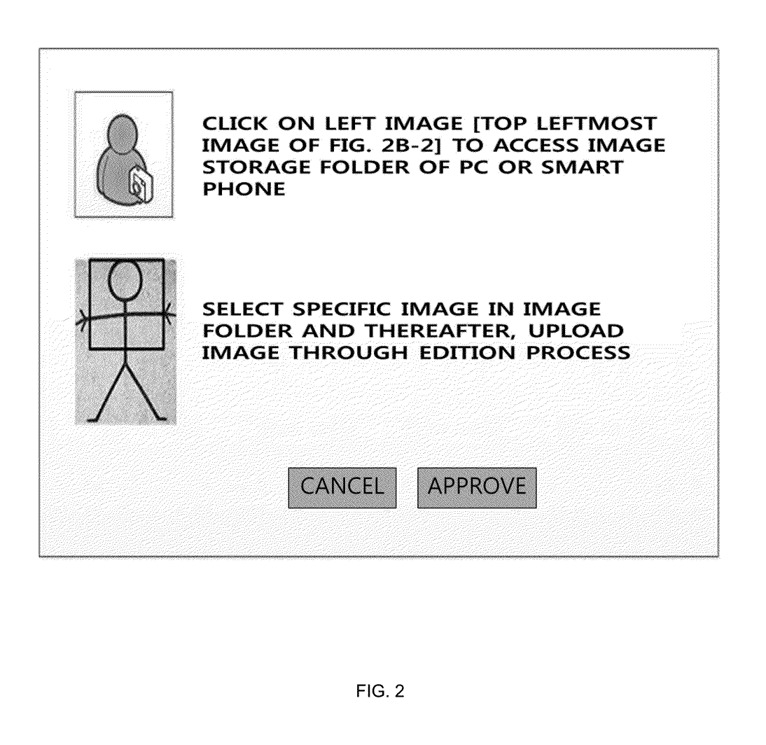

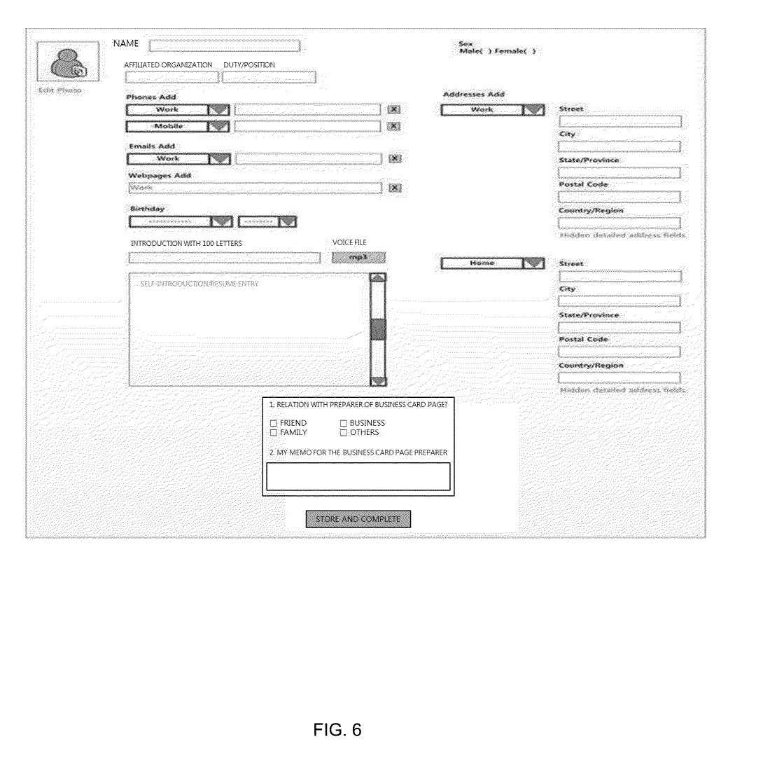

FIGS. 2 to 6 are exemplary diagrams of a user interface screen according to the exemplary embodiment of the present invention.

Referring to FIG. 2, the user is configured to upload his/her own photo on the user terminal 200 as a user interface screen provided to the user terminal 200 in the cloud server 100.

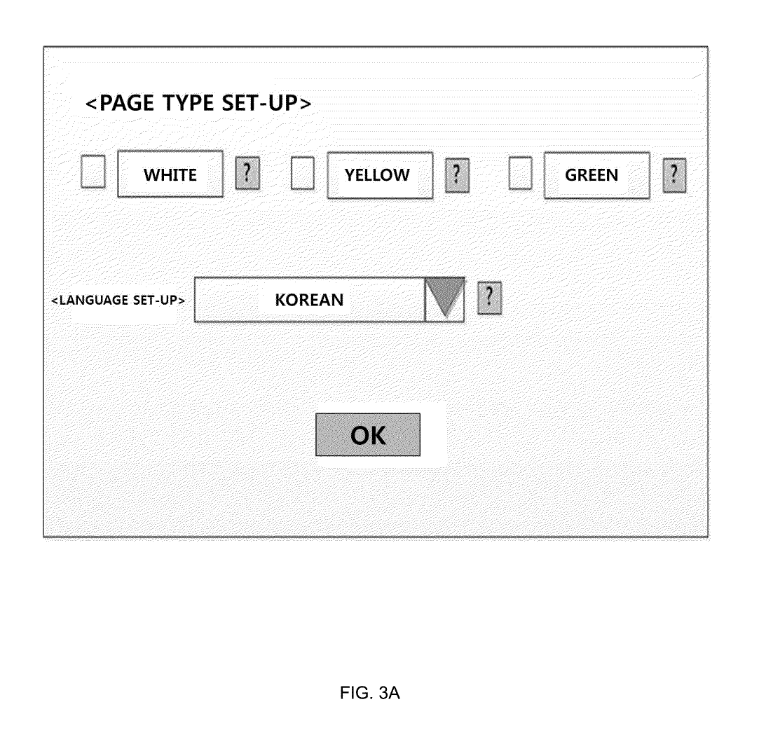

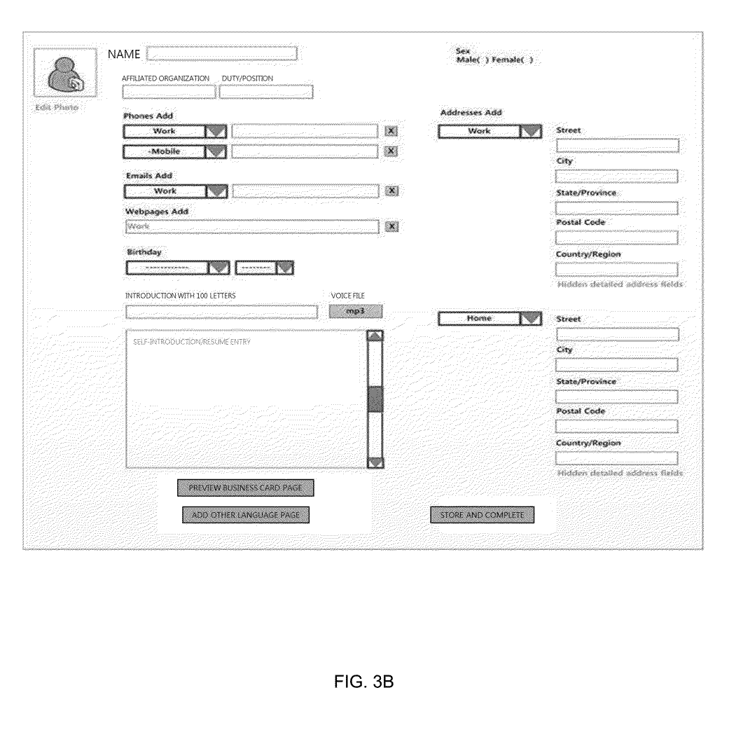

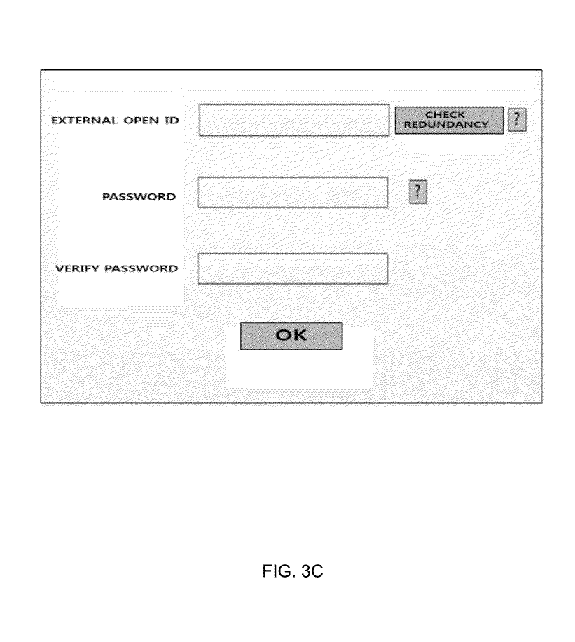

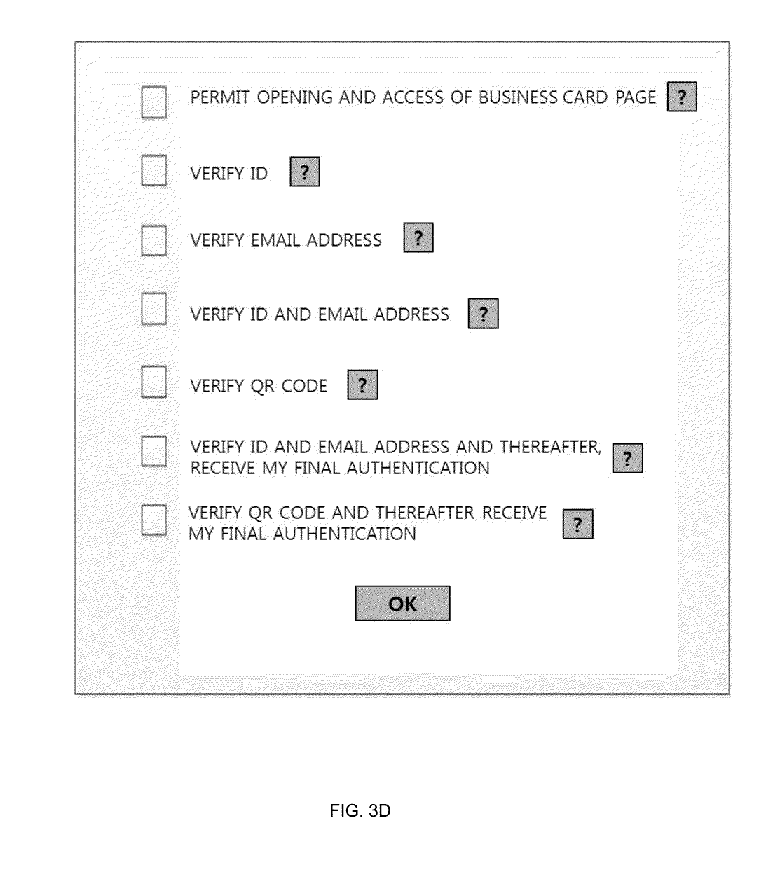

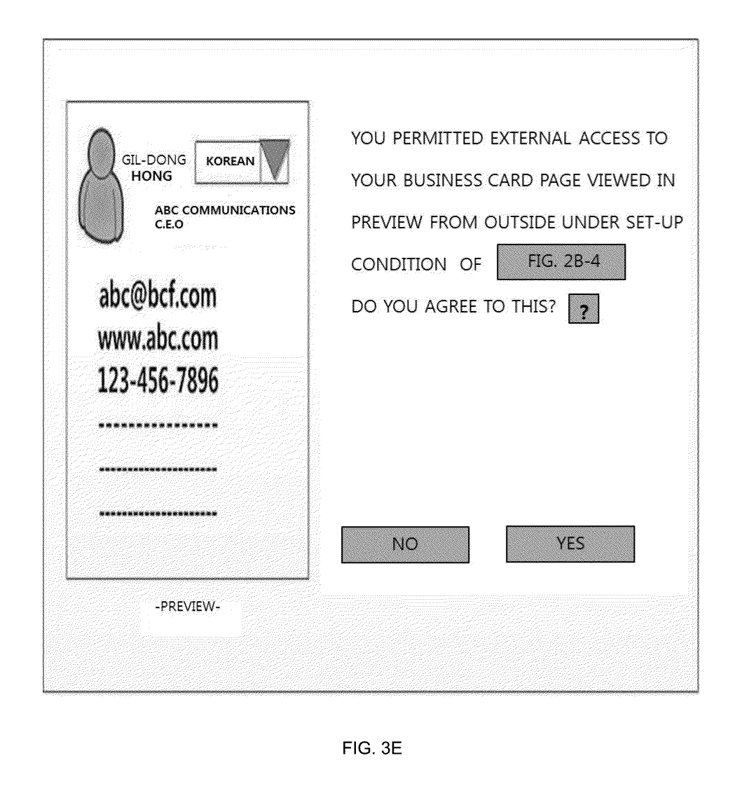

FIGS. 3A to 3E illustrate a screen for the user to select, write, and upload the business card information on the user terminal 200 as the user interface screen provided to the user terminal 200 in the cloud server 100.

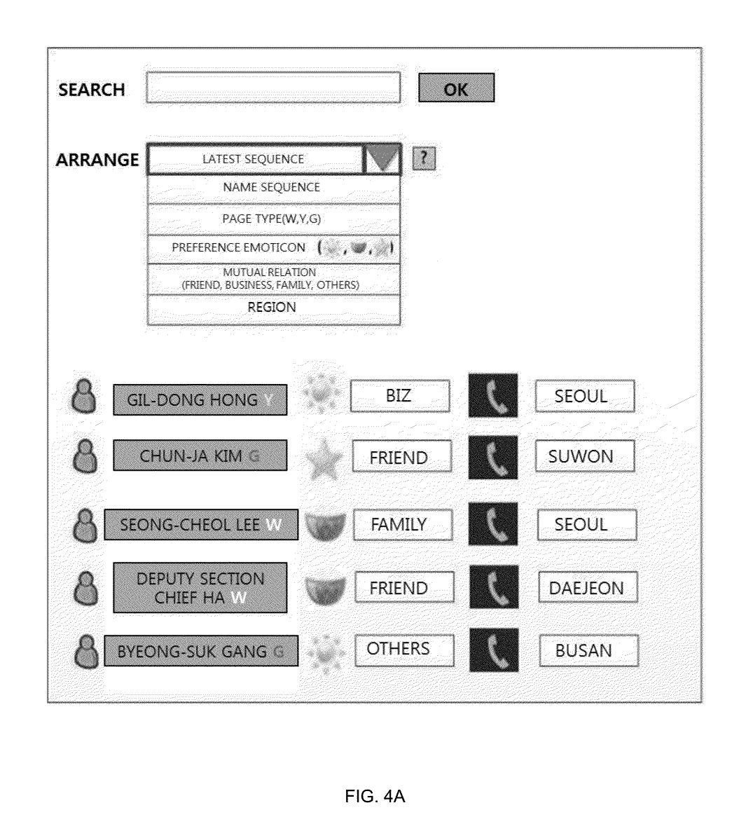

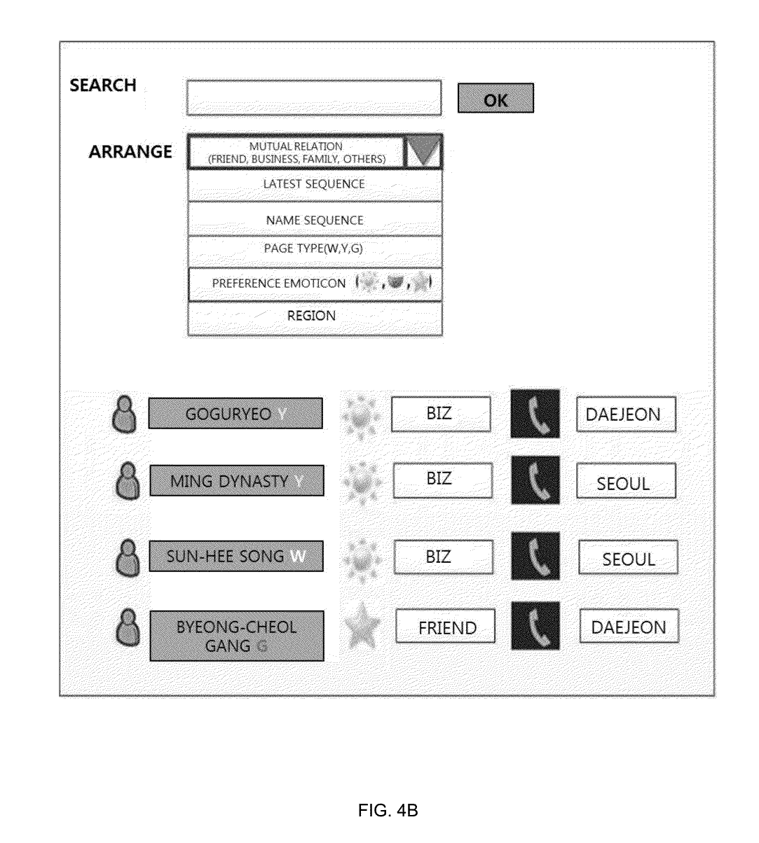

Referring to FIGS. 4A and 4B, the counterpart terminal 300 is configured to have each name, region, preference, emoticon, and the like as a list on the installed application and manage the list by generating a classification such as a friend or client as the user interface screen provided to the counterpart terminal 300 in the cloud server 100.

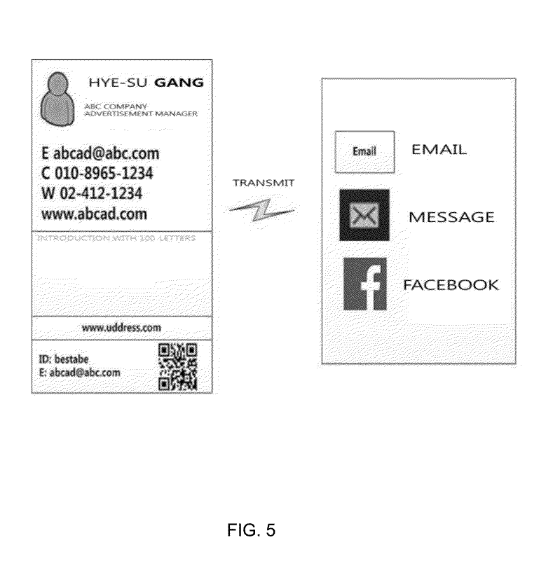

Referring to FIG. 5, the user is configured to share the business card page by another counterpart terminal 300 on the user terminal 200 as the user interface screen provided to the user terminal 200 in the cloud server 100. Accordingly, in this case, even in the state where the counterpart does not join in the application of the present invention as member, the counterpart may directly inquire the business card through a webpage provided through the email, and the like. In this case, the counterpart may directly inquire the business page information of the user even though the counterpart does not join as the member without the existing required ID, email, or combination thereof at the time of accessing the information of the user.

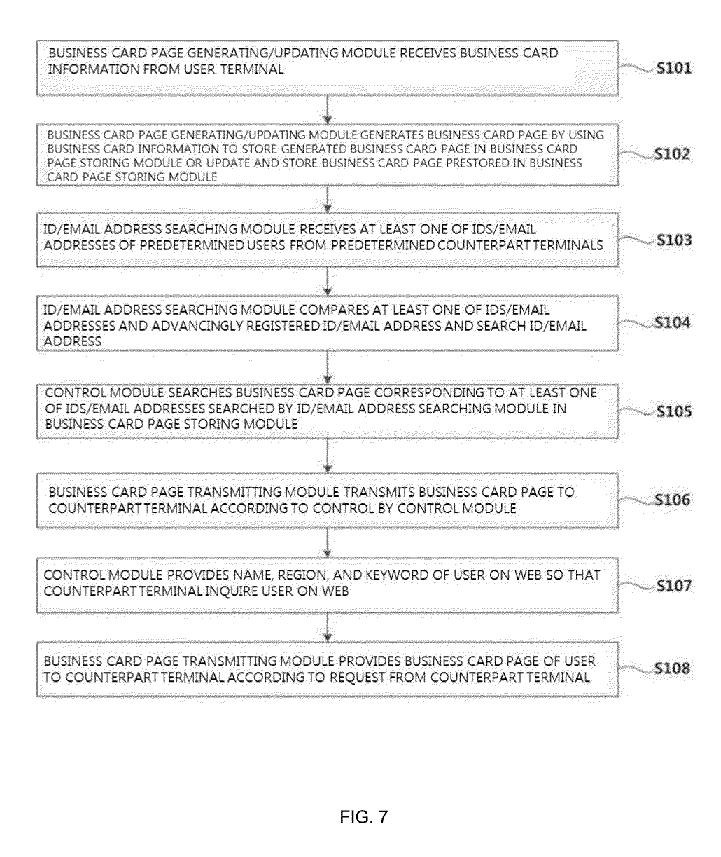

FIG. 7 is a flowchart of a method for providing a business card page of a cloud server according to another exemplary embodiment of the present invention.

Referring to FIG. 7, the business card page generating/updating module 150 receives the business card information from the user terminal (S101).

Next, the business card page generating/updating module 150 generates the business card page by using the advancingly received business card information and stores the generated business card page in the business card page storing module 110 or updates and stores the business card page prestored in the business card page storing module 110 (S102).

In this case, the user may be configured to generate or update the business card page by accessing the business card page generating/updating module 150 by combining an email address used in initial member registration and a password directly made and used by the user on the system application of the present invention.

In more detail, one business card page among a personal introduction business card page, a club/organization associated business card page, and a personal enterprise business card page may be configured to be generated to correspond to the ID and the email address of the user. Further, the business card page may be additionally configured for each language. By adding the business page for introducing the user himself/herself by various languages, the user may be configured to introduce himself/herself to counterparts in different language groups in addition to user's homeland people.

Next, the ID/email address searching module 120 receives at least one of predetermined IDs/email addresses of predetermined users from predetermined counterpart terminals (S103).

In this case, the ID/email address searching module 120 may be configured to receive the QR code data from the counterpart terminal instead of the ID/email address of the aforementioned scheme.

Next, the ID/email address searching module 120 compares at least one of the received IDs/email addresses and an advancingly registered ID/email address to verify whether both IDs/email addresses match each other (S104).

In this case, when the ID/email address searching module 120 receives the QR code data from the counterpart terminal 300, the ID/email address searching module 120 may be configured to compare the received QR code data and the QR code data of the user, which is advancingly registered in the business card page storing module 110 to verify whether both QR code data match each other.

Herein, when the ID/email address searching module 120 additionally requests the authentication procedure according to an advance set-up by the user while receiving the ID and the email address from the counterpart terminal 300, the control module 140 may be configured to permit the counterpart terminal 200 to access the business card page storing module of the user at last by receiving the authentication information only when the user finally approves the authentication scheme.

The control module 140 is configured to allow the business card page storing module 110 to search the business card page corresponding to at least one of the IDs/email addresses searched by the ID/email address searching module 120 (S105).

In this case, the ID/email address searching module 120 may be configured to search the business card page advancingly stored in the business card page storing module 110 to correspond to the searched QR code data.

Next, the business card page transmitting module 130 transmits the searched corresponding business card page or business card page list item to the counterpart terminal 300 according to the control by the control module 140 (S106).

Herein, in step S104, when the ID/email address searching module 120 additionally requests the authentication procedure and as a result, when the ID/email address searching module 120 is authenticated by the control module 140 by acquiring the authentication from the user, the business card page transmitting module 130 may be configured to allow the counterpart terminal 300 to view the business card page or the business card page list item corresponding to the ID and the email address.

Next, the control module 140 arranges and provides a list of users who access the counterpart terminal 300 minimally once or more in the meantime, that is, a list item which may be constituted by category classifications such as an image, a name, a region, a friend/business/family/other, and the like, a preference emoticon such as sun/moon/start, and the like for each sequence based on a latest sequence, a name sequence, a region sequence, a category classification sequence, or a preference emoticon sequence according to an inquiry preference so as to inquire the user business card page list on the Web in the case of an initial screen of the counterpart terminal 300.

Next, when a specific list item is selected on the initial screen or a specific list item is selected among associated list results acquired through the search function according to the request by the counterpart terminal 300, the business page transmitting module 130 provides the corresponding business card page to the counterpart terminal 300 (S108).

As described above, the exemplary embodiments have been described and illustrated in the drawings and the specification. The exemplary embodiments were chosen and described in order to explain certain principles of the invention and their practical application, to thereby enable others skilled in the art to make and utilize various exemplary embodiments of the present invention, as well as various alternatives and modifications thereof. As is evident from the foregoing description, certain aspects of the present invention are not limited by the particular details of the examples illustrated herein, and it is therefore contemplated that other modifications and applications, or equivalents thereof, will occur to those skilled in the art. Many changes, modifications, variations and other uses and applications of the present construction will, however, become apparent to those skilled in the art after considering the specification and the accompanying drawings. All such changes, modifications, variations and other uses and applications which do not depart from the spirit and scope of the invention are deemed to be covered by the invention which is limited only by the claims which follow.

### REFERENCE NUMERALS

100: A Cloud Server
110: Business Card Page Storing Module
120: Id/Email Address Searching Module
130: Business Card Page Transmitting Module
140: Control Module
150: Business Card Page Generating/Updating Module
160: Counterpart Editing/Storing Module
200: User Terminal
300: Counterpart Terminal

What is claimed is:

1. A cloud server for providing a business card page, comprising:
a business card page storing module storing a business card page of a user corresponding to an ID/email address advancingly registered;
an ID/email address searching module receiving at least one of the ID/email address of the user from a predetermined counterpart terminal and when the received ID/email address is compared with the ID/email address which is advancingly registered and both IDs/email addresses coincide with each other, searching the ID/email address so as to inquire the corresponding business card page; and
a business card page transmitting module transmitting the business card page stored in the business card page storing module to the counterpart terminal connected through a control module,
wherein the control module controls the business card page storing module to search the business card page corresponding to at least one of the IDs/email addresses searched by the ID/email address searching module and the business card page transmitting module to transmit the searched business card page to the counterpart terminal,
the business card page of the user includes multiple independent business card pages having different exposure degrees or contents of business card information, and
the control module searches a first business card page among the multiple business card pages when only the ID of the user is received from the counterpart terminal and searches a second business card page among the multiple business card pages when only the email address of the user is received from the counterpart terminal, or searches a third business card page among the multiple business card pages when both the ID and the email address of the user are received from the counterpart terminal to control the business card page transmitting module to transmit the searched business card page among the multiple business card pages to the counterpart terminal.

2. The server of claim 1, further comprising:
an ID/email address providing module providing a business card page list in which the ID/email address, a name of the user, an image, or a region is written so as for the counterpart terminal to search the business card page.

3. The server of claim 1, wherein the control module controls the ID/email address searching module to transmit an authentication request to the user terminal according to an advance set-up of the user when receiving an ID and an email address from the counterpart terminal and the business card page transmitting module to transmit a business card page corresponding to the ID and the email address to the counterpart terminal when the user decides the authentication.

4. The server of claim 1, wherein the ID/email address searching module is configured to receive QR code data from the counterpart terminal, and compare the received QR code data and the QR code data of the user, which is advancingly registered in the business card page storing module to verify whether both QR code data match each other.

5. The server of claim 1, further comprising:
a business card page generating/updating module configured to receive the business card information from the user terminal, generate the business card page by using the business card information received from the user terminal and store the generated business card page in the business card page storing module or update and store the prestored business card page in the business card page storing module, and allow the counterpart terminal who accesses the corresponding user business card page storing module once or more to separately store a counterpart's unique memo content in the user business card page storing module or update and separately store the counterpart's unique memo content prestored in the business card page storing module.

6. The server of claim 5, wherein the control module is configured to control the business card page generating/updating module to generate one business card page among a white page to expose personal information, a yellow page to expose enterprise information, and a green page to expose club/organization information to correspond to the ID of the user, the email address of the user, a combination of the ID and the email address.

7. The server of claim 2, wherein the control module is configured to arrange and provide a latest list item sequence and the name of the user, a region, a classification, a preference emoticon, and the like for each sequence when the counterpart terminal logs in with respect to the user business card page list which the counterpart terminal has accessed through a first security access verification procedure on the Web so as to continuously inquire the user business card page list without an additional reverification procedure and control the business card page transmitting module to provide a specific business card page in the user list to the counterpart terminal according to a request by the counterpart terminal.

8. The server of claim 1, wherein the business card page storing module stores the business card page for each language.

9. A method for providing a business card page on a cloud server, the method comprising:
receiving, by an ID/email address searching module, at least one of ID/email addresses of predetermined users from predetermined counterpart terminals;
comparing, by the ID/email address searching module, at least one of the received IDs/email addresses and an advancingly registered ID/email address corresponding thereto to verify whether both IDs/email addresses match each other;
allowing, by the control module, the business card page storing module to search the business card page corresponding to at least one of the IDs/email addresses searched by the ID/email address searching module; and
controlling, by the control module, a business page transmitting module to view the searched business card page to the counterpart terminal,
wherein a business card page of a user includes multiple independent business card pages having different exposure degrees or contents of business card information, and
in the allowing, by the control module, the business card page storing module to search the business card page corresponding to at least one of the IDs/email addresses searched by the ID/email address searching module, the control module searches a first business card page among the multiple business card pages when only the ID of the user is received from the counterpart module and searches a second business card page among the multiple business card pages when only the email address of the user is received from the counterpart terminal, or searches a third business card page among the multiple business card pages when both the ID and the email address of the user are received from the counterpart terminal to control the business card page transmitting module to view the searched business card page among the multiple business card pages to the counterpart terminal.

10. The method of claim 9, further comprising:
before the receiving, by an ID/email address searching module, at least one of an ID/email address of a predetermined user from a predetermined counterpart terminal,
receiving, by a business card page generating/updating module, business card information from a user terminal; and
generating, by the business card page generating/updating module, the business card page by using the received business card information and storing the generated business card page in the business card page storing module or update and store the prestored business card page in the business card page storing module.

11. The method of claim 9, wherein:
in the comparing, by the ID/email address searching module, at least one of the received IDs/email addresses and an advancingly registered ID/email address corresponding thereto to verify whether both IDs/email addresses match each other,
when the ID/email address searching module receives that both IDs and email addresses match each other from the counterpart terminal, the control module is configured to additionally transmit an authentication request to the user terminal and as a result, permit access of the corresponding counterpart terminal to the corresponding business page storing module only when receiving the authentication information from the user terminal, and
in the controlling, by the control module, a business page transmitting module to view the searched business card page to the counterpart terminal,
when the counterpart terminal is authenticated by the control module, the business card page transmitting module is configured to view a business card page corresponding to the ID and the email address to the counterpart terminal.

12. The method of claim 11, wherein:
in the receiving, by an ID/email address searching module, at least one of an ID/email address of a predetermined user from a predetermined counterpart terminal,
the ID/email address searching module is configured to substitutively receive QR code data from the counter part terminal,
in the comparing, by the ID/email address searching module, at least one of the received IDs/email addresses and an ID/email address corresponding thereto to verify whether both IDs/email addresses match each other,
when the QR code data is received from the counterpart terminal, the received QR code data and the QR code data prestored in the business card page storing module are configured to be compared with each other to search whether both QR code data match each other, and
in the allowing, by the control module, the business card page storing module to search the business card page corresponding to at least one of the IDs/email addresses searched by the ID/email address searching module,
the business card page advancingly stored in the business card page storing module to correspond to the searched QR code data is configured to be searched.

13. The method of claim 12, wherein:
in the generating, by the business card page generating/updating module, the business card page by using the received business card information and storing the generated business card page in the business card page storing module or update and store the prestored business card page in the business card page storing module,
the business card page is configured to be generated or updated by accessing the business card page with the email address and a unique password of the user.

14. The method of claim 13, wherein:
in the generating, by the business card page generating/updating module, the business card page by using the received business card information and storing the generated business card page in the business card page storing module or update and store the prestored business card page in the business card page storing module,
the user is configured to generate at least one business card page among a white page to expose personal information, a yellow page to expose enterprise information, and a green page to expose club/organization information according to user selection during a subscription procedure.

15. The method of claim 14, further comprising:
arranging and providing, by the control module, a item list constituted by combinations of an image, a name, a region, a classification, a preference emoticon, a phone number/email address, and the like of the user on the Web according to a name sequence, a region sequence, a classification sequence, a preference emoticon sequence, and the like in addition to a latest access sequence so as for the counterpart terminal to inquire the user on the Web according to a specific sequence; and
providing, by the business card page transmitting module to the business card page of the user to the counterpart terminal according to a request by the counterpart terminal.

16. The cloud server of claim 1, wherein the business card page of the user includes multiple business card pages corresponding to multiple IDs/email addresses of the same user and the multiple business card pages include business information having different properties.

17. The cloud server of claim 1, wherein:
the business card page of the user includes a plurality of business card information and the plurality of business card information is exposed or not exposed according to an exposure level, and
the control module controls the exposure level differently according to authentication of the counterpart terminal or an authentication level of the counterpart terminal.

18. The cloud server of claim 1, further comprising:
a counterpart editing/storing module allowing the counterpart terminal to store the counterpart's unique memo by editing the business card page of the user to inquire both user information input from the user terminal and memory information input from the counterpart terminal in the business card page of the user.

19. The cloud server of claim 1, wherein:
when the counterpart terminal accesses the cloud server by using at least one of the ID/email address, a detailed address of the business card page is configured to include the ID/email address value, and
when the counterpart terminal accesses the cloud server by using the QR code, the detailed address of the business card page is configured to include values not associated with the ID/email address.
